(19) United States
(12) Patent Application Publication
(10) Pub. No.: US 2017/0110075 A1
(43) Pub. Date: Apr. 20, 2017

(54) Gate Driver Circuit and Application Display Device Thereof

(71) Applicant: Wuhan China Star Optoelectronics Technology Co., Ltd., Wuhan (CN)

(72) Inventors: Shangcao Cao, Shenzhen (CN); Juncheng Xiao, Shenzhen (CN)

(73) Assignee: Wuhan China Star Optoelectronics Technology Co., Ltd., Wuhan (CN)

(21) Appl. No.: 15/000,267

(22) Filed: Jan. 19, 2016

(30) Foreign Application Priority Data
Oct. 15, 2015 (CN) 2015106728799

(51) Int. Cl. G09G 3/36

(52) U.S. Cl. CPC G09G 3/3677; G09G 2300/0809; G09G 2310/0202; G09G 2310/0283

(57) ABSTRACT

The present disclosure provides a gate driver circuit, which includes a startup unit, a pull-up unit, a pull-down unit and an output unit. Said startup unit is used to output control signal during forward or reverse scanning. Said pull-up unit includes a first node, when said first control signal is high, said first node receives high voltage signal. Said pull-down unit includes a second node, said pull-down unit is also connected with the first node of said pull-up unit. Said output unit includes a third node and a fourth node, said third node is connected with the output terminal of said pull-up unit, said fourth node is the output terminal of said gate driver circuit, which is used to output a driving signal. The present disclosure also provides a display device which applies said gate driver circuit.

### BACKGROUND OF THE DISCLOSURE

1. Field of the Disclosure

The present disclosure relates to a display technical field, and in particular to a gate driver circuit and an application display device thereof.

2. The Related Arts

GOA, gate driver on array, is to use TFT, thin film transistor, liquid crystal display array process to produce gate driver on a thin film transistor array substrate, to achieve progressive scanning drive mode.

Touch panel has been widely used in various display purposes, report rate is an important indicator of point touch technology, which is usually set at a specific value (60) or more in order to meet the technical requirements, scan form is determined by their report rate, thus directly affecting the touch sensitivity, and the scan form of the touch technology is limited by the time limit of frame rate and the gate scan driving form.

Generally speaking for touch technology, the scan form of the driving electrode (Tx) is divided into two types, one is to use the blanking time after the display screen scanning for driving electrode scanning of touch, for the 60 Hz display device, the available scan time is generally less than 4 ms, the other one is to output in the gap of gate signals, at the mean time, in order to avoid the data signal interfering the driving electrode signal, it is required in segment region of the data, for high resolution product, the available time is very short, the single signal width of the driving electrode is less than 2 ms, time is too short to achieve, in particular to considering of touch technology matching normal display driving, it is limited too much on scanning for touch technology, it is hard to achieve 120 Hz, even or higher frequency scan form.

Therefore, to suspend GOA drive if required will achieve a better user experience.

### SUMMARY OF THE DISCLOSURE

The technical issue to be mainly solved by the present disclosure is to provide a forward and reverse scan gate drive circuit which can suspend in midway.

In order to solve the above technical issue, a technical solution adopted by the present disclosure is:

A gate driver circuit, which includes:

A startup unit, said startup unit including a first driving signal input terminal used to receive a first driving signal, said startup unit including a second driving signal input terminal used to receive a second driving signal, said startup unit also being used to receive a first scan signal and a second scan signal, said first scan signal and said second signal being used to control said startup unit to output a first control signal, said first control signal being said first driving signal or said second driving signal;

A pull-up unit, said pull-up unit including a first node and a high voltage input terminal, said pull-up unit being connected with said startup unit in order to receive said first driving signal and said second driving signal, when said first control signal is high, said first node receiving high voltage signal provided by said high voltage input terminal;

A pull-down unit, said pull-down unit including a second node, a first timing signal terminal, a second timing signal terminal and a low voltage input terminal, said first timing signal terminal being used to receive a first timing signal, said second timing signal terminal being used to receive a second timing signal, said low voltage input terminal being used to provide a low voltage signal, said pull-down unit being connected with said startup unit in order to receive said first control signal, said pull-down unit being also connected with said first node of said pull-up unit;

An output unit, said output unit including a third node and fourth node, said third node being connected with output terminal of said pull-up unit, said fourth node being output terminal of said gate driver circuit, which is used to output a driving signal;

When said first scan signal being high, said second scan signal being low, when said first timing signal terminal being high, said first control signal being high;

When said first scan signal being low, said second scan signal being high, when said second timing signal terminal being high, said fourth node being high.

Wherein said startup unit also including a first transistor and a second transistor, first terminal of said first transistor receiving said first scan signal, second terminal of said first transistor being connected with said first driving signal input terminal; first terminal of said second transistor receiving said second scan signal, second terminal of said second transistor being connected with said second driving signal input terminal, third terminal of said first transistor being connected with third terminal of said second transistor.

Wherein said pull-up unit also including a third transistor, fourth transistor and first capacitor, first terminal of said third transistor being connected with third terminals of said first transistor and said second transistor, second terminal of said third transistor being connected with said first node, third terminal of said third transistor being connected with said high voltage input terminal, first terminal of said fourth transistor being connected with said high voltage input terminal, second terminal of said fourth transistor being connected with said first node, said first node being connected with ground through said first capacitor.

Wherein said output unit also including a fifth transistor and a second capacitor, said third node being connected with third terminal of said fourth transistor, first terminal of said fifth transistor being connected with said third node, second terminal of said fifth transistor being connected with said second timing signal terminal, third terminal of said fifth transistor being connected with said fourth node, said third node being connected with said fourth node through said second capacitor.

Wherein said pull-down unit also including sixth to twelfth transistors and a third capacitor, first terminal of said sixth transistor being connected with said second node, second terminal of said sixth transistor being connected with said fourth node, third terminal of said sixth transistor being connected with said low voltage input terminal, first terminal of said seventh transistor being connected said second node, second terminal of said seventh transistor being connected with said first node, third terminal of said seventh transistor being connected with said low voltage input terminal, first terminal of said eighth transistor being connected with third terminal of said first transistor, second terminal of said eighth transistor being connected with said second node, third terminal of said eighth transistor being connected with said low voltage input terminal, first terminal of said ninth transistor being connected with third terminal of said first transistor, second terminal of said ninth transistor being connected with said high voltage input terminal through said second capacitor, third terminal of said ninth transistor being connected with said low voltage input terminal, first terminal and second terminal of said tenth transistor being connected with said second timing signal terminal, third terminal of said tenth transistor being connected with second terminal of said ninth transistor, first terminal of said eleventh transistor being connected with second terminal of said ninth transistor, second terminal of said eleventh transistor being connected with said high voltage input terminal, first terminal of said twelfth transistor being connected with said first timing signal terminal, second terminal of said twelfth transistor being connected with third terminal of said eleventh transistor, third terminal of said twelfth transistor being connected with said second node.

Wherein said pull-down unit also including a thirteenth transistor, first terminal of said thirteenth transistor being connected with said fourth node, second terminal of said thirteenth transistor being connected with said second node, third terminal of said thirteenth transistor being connected with said low voltage input terminal.

Wherein transistors in said gate driver circuit are N-channel FET, wherein first terminal of the transistor corresponds to the gate of FET, second terminal of the transistor corresponds to the drain of FET, third terminal of the transistor corresponds to the source of FET.

Wherein said fourth node being connected with a horizontal scan line.

Wherein when said first scan signal being high, said second scan signal being low, said gate driver circuit being in forward scanning state.

Wherein when said first scan signal being low, said second scan signal being high, said gate driver circuit being in reverse scanning state.

The other technical solution adopted by the present disclosure is to provide a display device, said display device including said gate driver circuit as described above.

The benefit effect of the present disclosure is: to distinguish the situation of the prior art, the gate driver circuit provided by the present disclosure could suspend the output high voltage signal if required through the circuit design and the timing signal, and pull high the timing signal when recovering in order to keep on scanning. Said gate driver circuit could effectively prevent the node leakage affecting the circuit. The gate driver circuit can be used in the device within the internal touch panel, to achieve the narrow border design.

### BRIEF DESCRIPTION OF THE DRAWINGS

FIG. 1 is a circuit diagram of the preferred embodiment of a gate driver circuit 100 of the present disclosure;

FIG. 2 is a timing chart of the preferred embodiment of a gate driver circuit 100 in FIG. 1;

FIG. 3 is a circuit diagram of the other preferred embodiment of a gate driver circuit 100 of the present disclosure;

FIG. 4 is a structure schematic diagram of a display device of the present disclosure.

### DETAILED DESCRIPTION OF THE PREFERRED EMBODIMENTS

Following combines the drawings and embodiments to describe the present disclosure in detail.

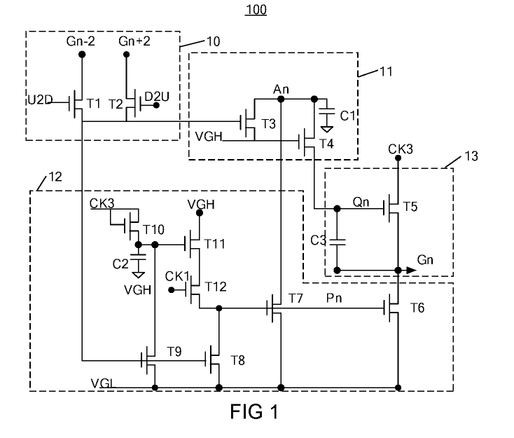

Refer to FIG. 1, the preferred embodiment of the gate driver circuit 100 of the present disclosure includes a startup unit 10, a pull-up unit 11, a pull-down unit 12 and an output unit 13.

Said startup unit 10 includes a driving signal input terminal Gn−2, a driving signal input terminal Gn+2, a transistor T1, a transistor T2.

First terminal of said transistor T1 receive a scan signal U2D, second terminal of said transistor T1 is connected with said driving signal input terminal Gn−2; first terminal of said transistor T2 receives a scan signal D2U, second terminal of said transistor T2 is connected with said driving signal input terminal Gn+2. Third terminal of said transistor T1 is connected with third terminal of said transistor T2.

Said pull-up unit 11 includes a node An, a transistor T3, a transistor T4, a capacitor C1 and a high voltage input terminal VGH.

First terminal of said transistor T3 is connected with third terminals of said transistor T1 and said transistor T2, second terminal of said transistor T3 is connected with said node An, third terminal of said transistor T3 is connected with said high voltage input terminal VGH. First terminal of said transistor T4 is connected with said high voltage input voltage VGH, second terminal of said transistor T4 is connected with said node An, said node An is connected with ground through said capacitor C1.

Said output unit 13 includes a node Qn, a node Gn, a transistor T5, a timing signal terminal CK3 and a capacitor C3.

Said node Qn is connected with third terminal of said transistor T4. First terminal of said transistor T5 is connected with said node Qn, second terminal of said transistor T5 is connected with said timing signal terminal CK3, third terminal of said transistor T5 is connected with said node Gn. Said Qn is connected with said node Gn through said capacitor C3.

Said pull-down unit 12 includes transistors T6-T12, a timing signal CK1, a node Pn, a low voltage input terminal and a capacitor C2.

First terminal of said transistor T6 is connected with said node Pn, second terminal of said transistor T6 is connected with said node Gn, third terminal of said transistor T6 is connected with said low voltage input terminal VGL. First terminal of said transistor T7 is connected with said node Pn, second terminal of said transistor T7 is connected with said node An, third terminal of said transistor T7 is connected with said low voltage input terminal VGL. First terminal of said transistor T8 is connected with third terminal of said transistor T1, second terminal of said transistor T8 is connected with said node Pn, third terminal of said transistor T8 is connected with said low voltage input terminal VGL. First terminal of said transistor T9 is connected with third terminal of said transistor T1, second terminal of said transistor T9 is connected with said high voltage input terminal VGH through said capacitor C2, third terminal of said transistor T9 is connected with said low voltage input terminal VGL. First terminal and second terminal of said transistor T10 is connected with said timing signal terminal CK3, third terminal of said transistor T10 is connected with second terminal of said transistor T9. First terminal of said transistor T11 is connected with said transistor T9, second terminal of said transistor T11 is connected with said high voltage input terminal VGH. First terminal of said transistor T12 is connected with said timing signal terminal CK1, second terminal of said transistor T12 is connected with third terminal of said transistor T11, third terminal of said transistor T12 is connected with said node Pn.

In the present embodiment, said node Gn is connected with said nth horizontal scan line, said gate driver circuit 100 is used to charge said nth horizontal scan line.

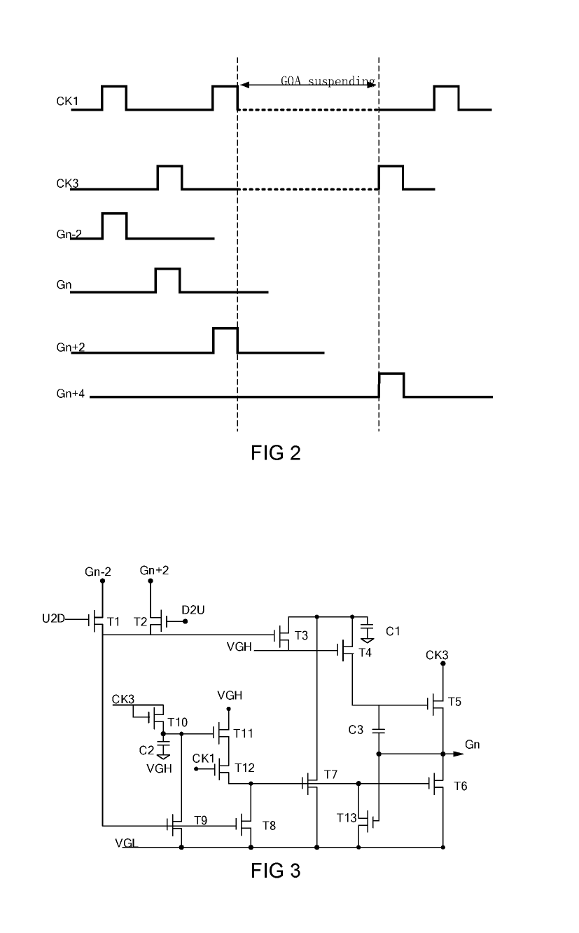

Refer to FIG. 2, FIG. 2 is a timing chart of the preferred embodiment of a gate driver circuit 100.

When said gate driver circuit 100 forward scans, said scan signal U2D is high, said scan signal D2U is low, first terminal of said transistor T1 is high, between second terminal and third terminal of said transistor T1 is on. First terminal of said transistor T2 is low, between second terminal and third terminal of said transistor T2 is off. First terminals of said transistor T3, transistor T4 and transistor T5 are high, said transistor T3, transistor T4 and transistor T5 are on. Node An is high. Node Qn is high. First terminal of said transistor T9 and said transistor T8 are high, said transistor T9 is on, said transistor T8 is on, said node Pn is connected with said low voltage input terminal VGL through said transistor T8, said node Pn is low. First terminals of said transistor T7 and transistor T6 are low, said transistor T7 and transistor T6 are off.

When timing signal terminal CK3 is high, node Gn is high, node Qn couples to high through said capacitor C3. Said transistor T10 is on, said capacitor C2 starts charging. Said transistor T12 is off, at the mean time, said node Pn is still low.

When said timing signal terminal CK1 is high, said transistor T11 and transistor T12 is on, said node Pn is connected with said high voltage input terminal VGH, said node Pn is high, said transistor T7 is on, said node An becomes low, then said node Qn becomes low, said transistor T5 is off, said node Gn is low.

When GOA is required to recover during suspending, said timing signal terminal CK3 becomes high, at the mean time, said horizontal scan line Gn+4 becomes high, the scanning before suspending could keep on.

When said gate driver circuit 100 reverse scans, said scan signal U2D is low, said scan signal D2U is high, said transistor T2 is on, said transistor T1 is off, said horizontal scan line G(n+1) becomes G(n−1) on the timing, the relationship of said node output signal and said timing signal is similar to forward scanning, there is no more description.

In the present embodiment, said pull-up unit 11 can effectively prevent said node Qn from generating leakage through said transistor T4 and said capacitor C1 design.

FIG. 3 is a circuit diagram of the other preferred embodiment of a gate driver circuit 100 of the present disclosure, wherein said pull-down unit 12 also includes a transistor T13, first terminal of said transistor T13 is connected with said node Gn, second terminal of said transistor T13 is connected with said node Pn, third terminal of said transistor T13 is connected with said low voltage input terminal VGL. Said transistor T13 is used to ensure that when said node Gn outputs high voltage signal, said node Pn is low.

In the present embodiment, said transistors T1-T13 are N-channel FET. First terminal of said transistor corresponds to the gate of FET, second terminal of said transistor corresponds to the drain of FET, third terminal of said transistor corresponds to the source of FET.

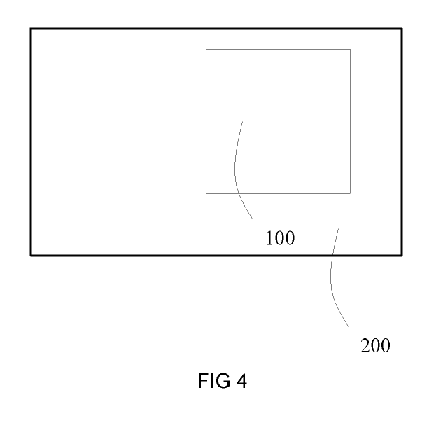

As shown in FIG. 4, in the present embodiment, said display device 200 is narrow border design within an internal touch panel, said display device 200 includes said gate driver circuit 100 of the present disclosure.

Comparing to the prior art, said gate driver circuit 100 provided by the present disclosure can suspend to output high voltage signal if required through the circuit design and timing signal control, and can keep on the previous scanning through pull high the timing signal. Said gate driver circuit 100 also can prevent said node Qn from generating leakage to affect the circuit through said transistor T4 and said capacitor C1 design. Said gate driver circuit 100 can be used to the device within an internal touch panel, in order to achieve the narrow border design.

The preferred embodiments according to the present disclosure are mentioned above, which cannot be used to define the scope of the right of the present disclosure. Those variations of equivalent structure or equivalent process according to the present specification and the drawings or directly or indirectly applied in other areas of technology are considered encompassed in the scope of protection defined by the clams of the present disclosure.

What is claimed is:

1. A gate driver circuit, wherein it includes:
a startup unit, said startup unit including a first driving signal input terminal used to receive a first driving signal, said startup unit including a second driving signal input terminal used to receive a second driving signal, said startup unit also being used to receive a first scan signal and a second scan signal, said first scan signal and said second signal being used to control said startup unit to output a first control signal, said first control signal being said first driving signal or said second driving signal;
a pull-up unit, said pull-up unit including a first node and a high voltage input terminal, said pull-up unit being connected with said startup unit in order to receive said first driving signal and said second driving signal, when said first control signal is high, said first node receiving high voltage signal provided by said high voltage input terminal;
a pull-down unit, said pull-down unit including a second node, a first timing signal terminal, a second timing signal terminal and a low voltage input terminal, said first timing signal terminal being used to receive a first timing signal, said second timing signal terminal being used to receive a second timing signal, said low voltage input terminal being used to provide a low voltage signal, said pull-down unit being connected with said startup unit in order to receive said first control signal, said pull-down unit being also connected with said first node of said pull-up unit;
an output unit, said output unit including a third node and fourth node, said third node being connected with output terminal of said pull-up unit, said fourth node being output terminal of said gate driver circuit, which is used to output a driving signal;
when said first scan signal being high, said second scan signal being low, when said first timing signal terminal being high, said first control signal being high;
when said first scan signal being low, said second scan signal being high, when said second timing signal terminal being high, said fourth node being high.

2. The gate driver circuit as claimed in claim 1, the characteristic of which is: said startup unit also including a first transistor and a second transistor, first terminal of said first transistor receiving said first scan signal, second terminal of said first transistor being connected with said first driving signal input terminal; first terminal of said second transistor receiving said second scan signal, second terminal of said second transistor being connected with said second driving signal input terminal, third terminal of said first transistor being connected with third terminal of said second transistor.

3. The gate driver circuit as claimed in claim 2, the characteristic of which is: said pull-up unit also including a third transistor, fourth transistor and first capacitor, first terminal of said third transistor being connected with third terminals of said first transistor and said second transistor, second terminal of said third transistor being connected with said first node, third terminal of said third transistor being connected with said high voltage input terminal, first terminal of said fourth transistor being connected with said high voltage input terminal, second terminal of said fourth transistor being connected with said first node, said first node being connected with ground through said first capacitor.

4. The gate driver circuit as claimed in claim 3, the characteristic of which is: said output unit also including a fifth transistor and a second capacitor, said third node being connected with third terminal of said fourth transistor, first terminal of said fifth transistor being connected with said third node, second terminal of said fifth transistor being connected with said second timing signal terminal, third terminal of said fifth transistor being connected with said fourth node, said third node being connected with said fourth node through said second capacitor.

5. The gate driver circuit as claimed in claim 4, the characteristic of which is: said pull-down unit also including sixth to twelfth transistors and a third capacitor, first terminal of said sixth transistor being connected with said second node, second terminal of said sixth transistor being connected with said fourth node, third terminal of said sixth transistor being connected with said low voltage input terminal, first terminal of said seventh transistor being connected said second node, second terminal of said seventh transistor being connected with said first node, third terminal of said seventh transistor being connected with said low voltage input terminal, first terminal of said eighth transistor being connected with third terminal of said first transistor, second terminal of said eighth transistor being connected with said second node, third terminal of said eighth transistor being connected with said low voltage input terminal, first terminal of said ninth transistor being connected with third terminal of said first transistor, second terminal of said ninth transistor being connected with said high voltage input terminal through said second capacitor, third terminal of said ninth transistor being connected with said low voltage input terminal, first terminal and second terminal of said tenth transistor being connected with said second timing signal terminal, third terminal of said tenth transistor being connected with second terminal of said ninth transistor, first terminal of said eleventh transistor being connected with second terminal of said ninth transistor, second terminal of said eleventh transistor being connected with said high voltage input terminal, first terminal of said twelfth transistor being connected with said first timing signal terminal, second terminal of said twelfth transistor being connected with third terminal of said eleventh transistor, third terminal of said twelfth transistor being connected with said second node.

6. The gate driver circuit as claimed in claim 5, the characteristic of which is: said pull-down unit also including a thirteenth transistor, first terminal of said thirteenth transistor being connected with said fourth node, second terminal of said thirteenth transistor being connected with said second node, third terminal of said thirteenth transistor being connected with said low voltage input terminal.

7. The gate driver circuit as claimed in claim 1, the characteristic of which is: said fourth node being connected with a horizontal scan line.

8. The gate driver circuit as claimed in claim 2, the characteristic of which is: when said first scan signal being high, said second scan signal being low, said gate driver circuit being in forward scanning state.

9. The gate driver circuit as claimed in claim 2, the characteristic of which is: when said first scan signal being low, said second scan signal being high, said gate driver circuit being in reverse scanning state.

10. A display device, the characteristic of which is: said display device including said gate driver circuit as claimed in claim 1
